(19) United States
(12) Patent Application Publication
(10) Pub. No.: US 2015/0111126 A1
(43) Pub. Date: Apr. 23, 2015

(54) CATALYST TREATMENT FOR SOLID POLYMER ELECTROLYTE FUEL CELLS

(71) Applicants: Daimler AG, Stuttgart (DE); Ford Motor Company, Dearborn, MI (US)

(72) Inventors: Rajesh Bashyam, Richmond (CA); Prasanna Mani, Surrey (CA)

(21) Appl. No.: 14/511,258

(22) Filed: Oct. 10, 2014

Related U.S. Application Data
(60) Provisional application No. 61/893,148, filed on Oct. 19, 2013.

(51) Int. Cl. H01M 4/92; H01M 8/10

(52) U.S. Cl. CPC H01M 4/923; H01M 4/926; H01M 8/1018; H01M 2008/1095; H01M 2250/20
USPC 429/479; 502/208; 502/213; 502/181; 429/535

(57) ABSTRACT

The high current density performance of solid polymer electrolyte fuel cells using certain alloy catalyst compositions can be improved via appropriate treatment of the catalyst composition with a fluoro-phosphonic acid compound. In particular, fuel cells employing carbon supported Pt—Co cathode catalyst compositions with relatively high Co content benefit by treating the catalyst composition with 2-(perfluorohexyl) ethyl phosphonic acid.

### BACKGROUND

1. Field of the Invention

The present invention pertains to solid polymer electrolyte fuel cells, and particularly to catalyst treatments for obtaining improved cell performance.

2. Description of the Related Art

Solid polymer electrolyte fuel cells electrochemically convert reactants, namely fuel (such as hydrogen) and oxidant (such as oxygen or air), to generate electric power. These cells generally employ a proton conducting polymer membrane electrolyte between cathode and anode electrodes. A structure comprising a proton conducting polymer membrane sandwiched between these two electrodes is known as a membrane electrode assembly (MEA). MEAs in which the electrodes have been coated onto the membrane electrolyte to form a unitary structure are commercially available and are known as a catalyst coated membrane (CCM). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications. Fuel cell stacks can be further connected in arrays of interconnected stacks in series and/or parallel for use in automotive applications and the like.

Catalysts are used to enhance the rate of the electrochemical reactions which occur at the cell electrodes. Catalysts based on noble metals such as platinum are typically required in order to achieve acceptable reaction rates, particularly at the cathode side of the cell. To achieve the greatest catalytic activity per unit weight, the noble metal is generally disposed on a corrosion resistant support with an extremely high surface area, e.g. high surface area carbon particles.

However, noble metal catalyst materials are relatively quite expensive. In order to make fuel cells economically viable for automotive and other applications, there is a need to reduce the amount of noble metal (the loading) used in such cells, while still maintaining similar power densities and efficiencies. In addition, it is important that these catalyst characteristics do not degrade unacceptably over time. Providing such catalysts can be quite challenging.

One approach considered in the art is the use of certain noble metal alloys which have demonstrated enhanced activity over the noble metals per unit weight. For instance, alloys of Pt with base metals such as Co have demonstrated over two-fold activity increases for the oxygen reduction reaction taking place at the cathode in the kinetic operating region (amounting to about 20-40 mV gain). However, despite this kinetic advantage, such catalyst compositions suffer from relatively low performance in the mass transport operating regime (i.e. at high power or high current densities). For instance, state-of-the-art commercial CCMs comprising Pt—Co alloy cathode catalysts with Pt loadings in the range of about 0.25-0.4 mg Pt/cm² show good performance (about 2 times the mass activity) at low current densities but low performance at high current densities (e.g. greater than about 1.5 A/cm²) relative to Pt catalysts on the same carbon support. Some of the advantages and disadvantages of such alloys as cathode catalysts are discussed for instance in “Effect of Particle Size of Platinum and Platinum-Cobalt Catalysts on Stability”; K. Matsutani et al., Platinum Metals Rev., 54 (4) 223-232 and “Activity benchmarks and requirements for Pt, Pt-alloy, and non-Pt oxygen reduction catalysts for PEMFCs”, H. Gasteiger et al., Applied Catalysis B: Environmental 56 (2005) 9-35.

Thus, neither the common noble metal catalysts nor their alloys seemed able to satisfy the desired performance requirements of many applications at both low and high current densities. Mixtures of various kinds may be considered but with an expectation of a performance compromise at both low and high current densities. So instead, alloy catalyst compositions, such as Pt—Co, are presently considered predominantly for stationary applications and are less attractive for automotive applications which require higher power density.

Of late, phosphonic acids are being used to modify the surface properties of numerous materials for a variety of applications. As mentioned in “Phosphonate coupling molecules for the control of surface/interface properties and the synthesis of nanomaterials”, G. Guerrero et al., Dalton Trans. 2013 Aug 13; 42(35):12569-85, phosphonic acids are increasingly being used for controlling surface and interface properties in hybrid or composite materials, (opto)electronic devices and in the synthesis of nanomaterials. They are used in the surface modification of inorganic substrates with self-assembled monolayers and some recent applications include the development of organic electronic devices, photovoltaic cells, biomaterials, biosensors, supported catalysts and sorbents, corrosion inhibitors, and nanostructured composite materials.

For instance, in “High performance carbon-supported catalysts for fuel cells via phosphonation”, Z. Xu et al., Chem. Commun., 2003, 878-879, carbon-supported catalysts were phosphonated using 2-aminoethylphosphonic acid, and the resulting catalysts with largely enhanced proton conductivity performed substantially better than the untreated counterparts in proton-exchange membrane fuel cells. The carbon supported catalyst tested was 20% Pt/Vulcan XC-72. Other phosphonic acids were also used to treat similar catalyst compositions but the results were not as good.

Notwithstanding recent discoveries in the field, there is a continuing need to obtain improved cathode catalysts and/or structures, particularly for those based on Pt—Co alloy catalysts, so as to provide desirable performance at both low and high current densities while further reducing the amount of expensive noble metal required.

### SUMMARY

The performance at high current densities (e.g. greater than or about 1.5A/cm²) in solid polymer electrolyte fuel cells using certain alloy catalyst compositions can be improved by appropriately treating the catalyst composition with a fluoro-phosphonic acid compound. This is surprising because treatment is ineffective in closely related alloy catalyst compositions. In particular, improvement in current density capability has been observed in fuel cells in which the cathode comprises the treated catalyst composition.

Specifically, the catalyst compositions comprise a noble metal/non-noble metal alloy with a relatively high non-noble metal content, i.e. with an atomic ratio of non-noble metal to noble metal of greater than about 0.4. In particular, the noble metal/non-noble metal alloy can be Pt—Co, and further the noble metal/non-noble metal alloy can be supported on a carbon support. The fluoro-phosphonic acid compound used for treatment can be 2-(perfluorohexyl) ethyl phosphonic acid.

In these catalyst compositions, the phosphonic acid groups of the fluoro-phosphonic acid compound are expected to covalently bond to surface oxygen on the noble metal/non-noble metal alloy.

An appropriate method for treating such catalyst compositions comprises treating the composition before assembling the fuel cell. The catalyst composition is first obtained and then dispersed in a solution comprising a suitable fluoro-phosphonic acid compound. The liquid remaining after the dispersing step is then removed and thereafter the fuel cell can be assembled in a conventional manner. The removing step can be accomplished for instance by centrifuging the dispersion of catalyst composition and solution, decanting the supernatant after the centrifuging step, vacuum drying the precipitate after the centrifuging step, and then heating the vacuum dried precipitate in a hydrogen atmosphere at about 120° C.

### BRIEF DESCRIPTION OF THE DRAWINGS

FIG. 1a compares plots of cell voltage at 1.5 A/cm² versus accelerated stress test cycle number for a cell of the invention and a comparative cell.

FIG. 1b compares plots of cell voltage at 2.1 A/cm² versus accelerated stress test cycle number for a cell of the invention and a comparative cell.

FIG. 2a compares plots of cell voltage versus current density before accelerated stress testing for two cells of the invention and a comparative cell.

FIG. 2b compares plots of cell voltage versus current density after 20,000 accelerated stress test cycles for two cells of the invention and a comparative cell.

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%.

A fluoro-phosphonic acid compound refers to a phosphonic acid or phosphonate compound which comprises one or more fluorine atoms in its chemical structure.

The performance of solid polymer electrolyte fuel cells employing cathode catalysts comprising certain alloy compositions is improved by treating the catalyst composition with a fluoro-phosphonic acid compound during assembly.

The fuel cells can be of any conventional construction except for the cathode catalyst composition employed. And except for the additional step of treating the catalyst composition with fluoro-phosphonic acid, the fuel cell can be assembled in any conventional manner.

The cathode catalyst compositions involved comprise a noble metal/non-noble metal alloy with an atomic ratio of non-noble metal to noble metal of greater than about 0.4. In particular, the catalyst composition is a Pt—Co alloy supported on carbon in which the Co to Pt atomic ratio is greater than about 0.4

In one embodiment, the cathode catalyst composition is treated before incorporating it into a complete catalyst coated membrane (CCM). Conveniently this can be accomplished simply by dispersing the catalyst composition in a solution comprising an appropriate amount of a suitable fluoro-phosphonic acid and thereafter removing the liquid. For example, 2-(perfluorohexyl) ethyl phosphonic acid is a suitable fluoro-phosphonic acid and amounts in the range of 0.5% to 2.5% by weight with respect to the supported alloy catalyst composition can be appropriate for treatment.

In an exemplary method then, 0.5 weight % (with respect to the weight of the carbon supported catalyst) can be dissolved in reagent alcohol and added a dispersion of the catalyst composition. The mixture is then dispersed further and afterwards the liquid is removed. This can be accomplished in various ways, including for instance centrifuging the dispersion, decanting the supernatant, vacuum drying the precipitate, and then heating the precipitate in a hydrogen atmosphere at 120° C. for an adequate time (e.g. 2 hours). Thereafter, the fuel cell can be assembled in any conventional manner.

Without being bound by theory, it is hypothesized that the phosphonic groups in the 2-(perfluorohexyl) ethyl phosphonic acid covalently bond to surface oxygen on the surface of the alloy in the catalyst composition. Because fluoro compounds generally have high oxygen solubility, the performance improvement seen at high current densities might then be a result of the channelling of oxygen from adjacent ionomer directly to the catalyst composition nanoparticles.

The following Examples have been included to illustrate certain aspects of the invention but should not be construed as limiting in any way.

### EXAMPLES

The effect of treating several different Pt—Co compositions with 2-(perfluorohexyl) ethyl phosphonic acid was determined in the cell testing described below. The three Pt—Co compositions used in these experiments had varied ratios of Pt to Co in the compositions. These ratios and other properties of these commercially obtained carbon supported catalyst compositions are summarized in Table 1 below.

TABLE 1

| | | | | | | Average |
|---|---|---|---|---|---|---|
| | | | | | BET sur- | crystal- |
| Catalyst | | | Pt/Co | Co/Pt | face area | lite size |
| compoti- | Pt | Co | atomic | atomic | of catalyst | of alloy** |
| tion | wt %* | wt %* | ratio | ratio | (m²/g) | (nm) |
| Pt—Co #1 | 47.0 | 6.9 | 2.06 | 0.49 | 333 | 3.9 |
| Pt—Co #2 | 28.8 | 3.1 | 2.8 | 0.36 | 514 | 3.3 |
| Pt—Co #3 | 49.9 | 2.4 | 6.3 | 0.16 | 349 | 4.9 |

*weight % is expressed with respect to Pt—Co alloy plus carbon support
**as determined by X-ray diffraction

Where indicated below, the cathode catalyst compositions were treated with 2-(perfluorohexyl) ethyl phosphonic acid prior to preparing cathode ink dispersions for subsequent testing in cells. In the treatment process, an amount of the carbon supported catalyst composition was first dispersed in distilled water and reagent alcohol. Then, as indicated below, either 0.5 weight % (with respect to the weight of the carbon supported catalyst), 2.5 wt %, 5 wt %, or 10 wt % of 2-(perfluorohexyl) ethyl phosphonic acid dissolved in reagent alcohol was added to the dispersion. The mixture was dispersed further and then the liquid was removed. This was accomplished by centrifuging the dispersion, decanting the supernatant, vacuum drying the precipitate, and finally heating the precipitate in a hydrogen atmosphere at 120° C. for 2 hours.

Experimental fuel cells were made and tested using cathode catalysts comprising various treated and untreated compositions from Table 1 above. Specifically, cells comprising Pt—Co #1 treated with 0.5 wt % 2-(perfluorohexyl) ethyl phosphonic acid (denoted “0.5 wt % treated”), Pt—Co #1 treated with 2.5 wt % 2-(perfluorohexyl) ethyl phosphonic acid (denoted “2.5 wt % treated”), and untreated Pt—Co #1 (denoted “comparative”) were prepared. Also, a cell comprising Pt—Co #2 treated with 0.5 wt % of the 2-(perfluorohexyl) ethyl phosphonic acid and a cell comprising untreated Pt—Co #2 were prepared. And further, cells comprising Pt—Co #3 treated with either 2.5 wt %, 5 wt %, and 10 wt % of the 2-(perfluorohexyl) ethyl phosphonic acid were prepared along with a cell comprising untreated Pt—Co #3.

Each fuel cell used a catalyst coated membrane (CCM) comprising an ionomer membrane electrolyte and a standard anode catalyst layer (both from W. L. Gore) and a cathode catalyst layer of interest. The various cathode catalyst compositions were applied in the form of a catalyst layer to the CCM via a decal transfer process. First, suitable cathode ink dispersions were prepared and cast onto PTFE substrates. The ionomer to carbon weight ratios were adjusted to 1:1. The cathode catalyst ink dispersions were cast onto PTFE sheet substrates using metering rods, dried, and then decal-transfered using heat and pressure to the CCM.

Individual fuel cells with about 50 cm² active area were then assembled by hot press bonding carbon fibre gas diffusion layers onto each side of each CCM. Then, assembly was completed by providing carbon flow field plates adjacent each gas diffusion layer.

In testing, the fuel cells were supplied with hydrogen and air reactants. Initially, the cells were conditioned by operating under a high humidity condition (i.e. 70° C. and both reactants at 100% RH). Cell performance was then evaluated by obtaining polarization curves (voltage versus current density plots) at varying relative humidity conditions.

The fuel cells were subjected to accelerated stress testing which focused primarily on cathode catalyst layer degradation over time. This involved subjecting the fuel cell to voltage cycling between 0.1 and 1.0 volts using a square wave cycle of 2 sec and 2 sec duration respectively. After every 5000 cycles, cell performance was again evaluated by obtaining polarization curves as before. Representative results are shown in the following figures.

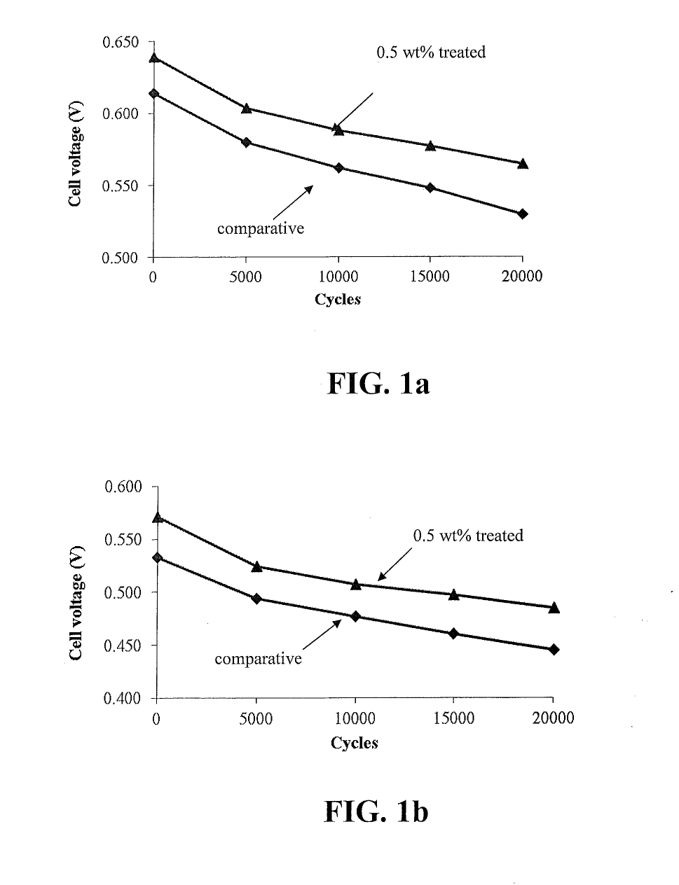

FIG. 1a compares the cell voltage plots at 1.5 A/cm² versus accelerated stress test cycle number (up to 20,000 cycles) for the 0.5 wt % treated Pt—Co #1 fuel cell and the untreated comparative Pt—Co #1 fuel cell. FIG. 1b provides a similar comparison at 2.1 A/cm². The 0.5 wt % treated fuel cell performs substantially better than the comparative fuel cell and the treatment did not negatively affect the degradation rate.

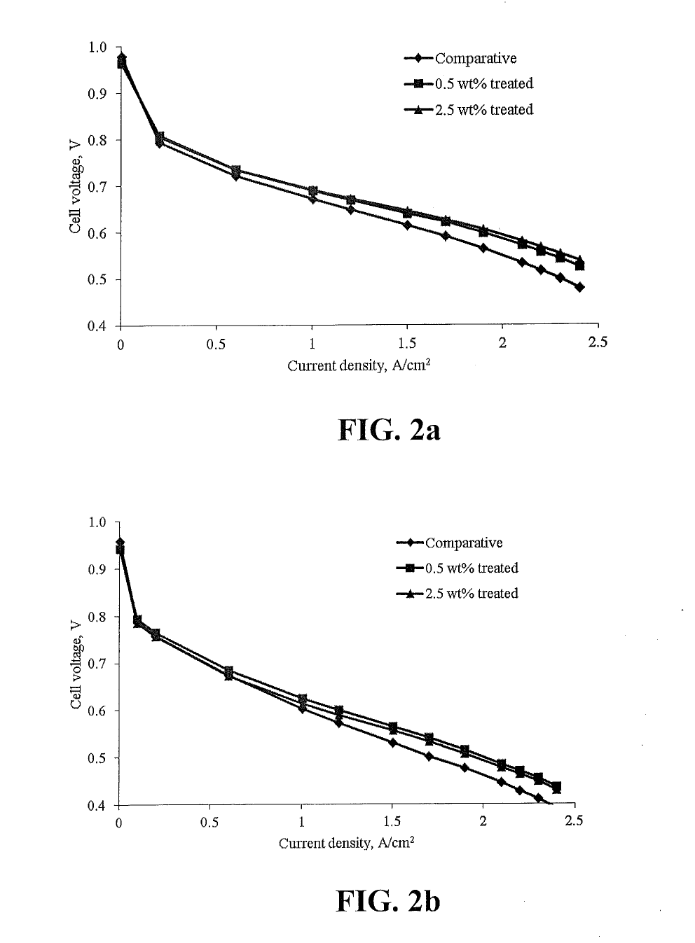

FIG. 2a compares polarization plots (cell voltage versus current density) before accelerated stress testing for the 0.5 wt % treated Pt—Co #1 fuel cell, the 2.5 wt % treated fuel cell, and the comparative Pt—Co #1 fuel cell. FIG. 2b provides a similar comparison after 20,000 accelerated stress test cycles. Both treated cells show similar improved polarization results compared to those for the comparative cell.

The fuel cells comprising the various treated and untreated Pt—Co #2 and Pt—Co #3 catalyst compositions were tested in a similar manner to the Pt—Co #1 fuel cells. However, no substantial difference was observed in the polarization plots between the fuel cell comprising 0.5 wt % acid treated Pt—Co #2 and the fuel cell comprising untreated Pt—Co #2, either before stress test cycling or after 20,000 accelerated stress test cycles. Further, no substantial difference was observed in the polarization plots between the fuel cells comprising 2.5 wt % or 5 wt % acid treated Pt—Co #3 and the fuel cell comprising untreated Pt—Co #3, either before stress test cycling or after 20,000 accelerated stress test cycles. In the case of the 10 wt % treated Pt—Co #3 fuel cell, no substantial difference was observed in its polarization plot and that of the untreated Pt—Co #3 fuel cell before stress test cycling started. After 20,000 accelerated stress test cycles though, the voltage of the 10 wt % treated Pt—Co #3 fuel cell was significantly worse than that of the untreated Pt—Co #3 fuel cell at high current densities (i.e. >1 A/cm²).

The Examples show that the performance of fuel cells using carbon supported Pt—Co alloy cathode catalysts can be significantly improved by treating the catalyst compositions with 2-(perfluorohexyl) ethyl phosphonic acid. However, this only appeared to be the case for Pt—Co compositions whose Co/Pt atomic ratio was greater than 0.4.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A catalyst composition for a solid polymer electrolyte fuel cell comprising a noble metal/non-noble metal alloy with an atomic ratio of non-noble metal to noble metal of greater than about 0.4 wherein the noble metal/non-noble metal alloy has been treated with a fluoro-phosphonic acid compound.

2. The catalyst composition according to claim 1, wherein the noble metal/non-noble metal alloy is Pt—Co.

3. The catalyst composition according to claim 1, wherein the noble metal/non-noble metal alloy is supported on a carbon support.

4. The catalyst composition according to claim 1, wherein the fluoro-phosphonic acid compound is 2-(perfluorohexyl) ethyl phosphonic acid.

5. A catalyst composition for a solid polymer electrolyte fuel cell comprising a noble metal/non-noble metal alloy and a fluoro-phosphonic acid compound wherein the metal alloy has an atomic ratio of non-noble metal to noble metal of greater than about 0.4 and has surface oxygen and wherein the phosphonic acid groups of the fluoro-phosphonic acid compound are covalently bonded to the surface oxygen on the metal alloy.

6. A solid polymer electrolyte fuel cell comprising a solid polymer electrolyte, an anode, and a cathode wherein the cathode comprises the catalyst composition of claim 1.

7. A method of increasing the current density capability of a solid polymer electrolyte fuel cell, the fuel cell comprising a solid polymer electrolyte, an anode, and a cathode, the cathode comprising a catalyst composition comprising a noble metal/non-noble metal alloy with an atomic ratio of non-noble metal to noble metal of greater than about 0.4, and the method comprising:
obtaining the catalyst composition before assembling the fuel cell;
dispersing the catalyst composition in a solution comprising a fluoro-phosphonic acid compound;
removing the liquid remaining after the dispersing step; and
assembling the fuel cell.

8. The method of claim 7 wherein the removing step comprises:
centrifuging the dispersion of catalyst composition and solution;
decanting the supernatant after the centrifuging step;
vacuum drying the precipitate after the centrifuging step; and
heating the vacuum dried precipitate in a hydrogen atmosphere at about 120° C.

9. The method of claim 7 wherein the current density capability is increased at current densities greater than or about 1.5 A/cm².
